(19) United States
(12) Patent Application Publication
(10) Pub. No.: US 2016/0347499 A1
(43) Pub. Date: Dec. 1, 2016

(54) PAINT CONTAINER

(71) Applicant: Alec Machin, Leicestershire (GB)

(72) Inventor: Alec Machin, Leicestershire (GB)

(21) Appl. No.: 14/721,643

(22) Filed: May 26, 2015

(51) Int. Cl. B65D 5/72; B65D 5/42; B44D 3/12; B65D 5/40

(52) U.S. Cl. CPC B65D 5/72; B65D 5/40; B65D 5/4266; B44D 3/12

(57) ABSTRACT

A paint container comprises a plurality of walls arranged circumferentially to form a hollow enclosure with a bore within which a volume of paint may be contained, each of the plurality of walls being divided from each neighboring wall by a respective fold-line (36); and a dispensing opening arranged to permit dispensing of any paint contained within the bore, wherein, upon application of a force to the plurality of walls, the plurality of walls are foldable along the fold-lines in order to apply pressure to any volume of paint contained within the bore to dispense paint through the dispensing opening.

### FIELD OF THE INVENTION

This invention relates to a paint container and a method of dispensing paint from a paint container.

### BACKGROUND

It is known to store paint in tins and tubes.

### SUMMARY OF THE INVENTION

According to a first aspect of the invention, there is provided a paint container comprising: a plurality of walls arranged circumferentially to form a hollow enclosure with a bore within which a volume of paint may be contained, each of the plurality of walls being divided from each neighboring wall by a respective fold-line; and a dispensing opening arranged to permit dispensing of any paint contained within the bore,
wherein, upon application of a force to the plurality of walls, the plurality of walls are foldable along the fold-lines in order to apply pressure to any volume of paint contained within the bore to dispense paint through the dispensing opening.

The arrangement of the plurality of walls and fold-lines in the foregoing manner not only enables dispensing of the paint from within the bore of the paint container, but also allows the paint container to be readily restored to a desired shape after the paint has been dispensed. The ability of the paint container to be readily restored to a desired shape after the paint dispensing step makes it practical to design the shape of the paint container to permit its stacking with other similarly shaped paint containers, since there is no permanent post-dispensing deformation of the paint container. This not only enables space-efficient storage of the paint container, but also allows the paint container to be displayed in an aesthetically pleasing fashion alongside the other similarly shaped paint containers.

The shape and structure of the paint container may vary as follows.

Each of the plurality of walls may be a planar wall. The provision of planar walls in the paint container allows for easier storage and stacking of the paint container when compared to a paint container with rounded walls.

The plurality of walls may be even in number.

In embodiments of the invention, the plurality of walls may be arranged circumferentially in a polygonal circumference to form the hollow enclosure. The use of a polygonal circumference allows for more efficient storage and stacking of the paint container when compared to a paint container with a non-polygonal circumference, e.g. a circular cross-section.

The polygonal circumference may be any one of: a triangular circumference; a square circumference; a rectangular circumference; a pentagonal circumference; a hexagonal circumference; an octagonal circumference; and a decagonal circumference. It will be appreciated that the polygonal circumference may be a circumference of any other polygonal shape.

In further embodiments of the invention, the plurality of walls may be arranged circumferentially in a polygonal circumference to form the hollow enclosure when there is no force applied to the plurality of walls to fold the plurality of walls along the fold-lines. Such an arrangement of the plurality of walls allows the paint container to be easily stored and stacked with other similarly shaped paint containers.

In still further embodiments of the invention, the plurality of walls may be arranged circumferentially in a circumference to form the hollow enclosure, the circumference having:
a first number of corners when there is no force applied to the plurality of walls to fold the plurality of walls along the fold-lines; and
a second number of corners when there is a force applied to the plurality of walls to fold the plurality of walls along the fold-lines,
wherein the second number of corners is higher than the first number of corners.

The arrangement of the plurality of walls in this manner permits the paint container to switch between: a first shape that permits easy stacking of the paint container; and a second shape that improves the dispensing of the paint from the paint container.

In one such example, the plurality of walls may be arranged circumferentially in a circumference to form the hollow enclosure, the circumference being:
any one of: a square circumference; and a rectangular circumference, when there is no force applied to the plurality of walls to fold the plurality of walls along the fold-lines; and
a hexagonal circumference when there is a force applied to the plurality of walls to fold the plurality of walls along the fold-lines.

In another such example, the plurality of walls may be arranged circumferentially in a circumference to form the hollow enclosure, the circumference being:
a octagonal circumference when there is no force applied to the plurality of walls to fold the plurality of walls along the fold-lines; and
a decagonal circumference when there is a force applied to the plurality of walls to fold the plurality of walls along the fold-lines.

Optionally the plurality of walls may be arranged circumferentially in a circumference to form the hollow enclosure with a plurality of first and second walls positioned alternately around the circumference. The width of each first wall along the circumference may be different from the width of each second wall along the circumference.

The material of the paint container may vary. For example, the plurality of walls may be made from at least one of: cardboard, corrugated cardboard, paper covered cardboard, clay covered cardboard, paper, plastic, plastic film, and metal.

In a preferred embodiment of the invention, the paint container further includes an end face extending between at least two of the plurality of walls so as to cover part or all of a cross-section of the bore. The provision of the end face in the paint container helps to contain the volume of paint within the bore.

Preferably the dispensing opening is formed on the end face. This makes it easier to dispense the paint through the dispensing opening when a force is applied to the plurality of walls.

The end face may be arranged to be planar when there is no force applied to the plurality of walls to fold the plurality of walls along the fold-lines. This makes it more convenient to store and stack the paint container.

The end face may include at least two end face portions divided by a fold-line, and the end face is arranged to fold along its fold-line and inwards towards the bore when there is a force applied to the plurality of walls to fold the plurality of walls along the fold-lines. Alternatively the end face may include at least two end face portions divided by a fold-line, and the end face is arranged to fold along its fold-line and outwards away from the bore when there is a force applied to the plurality of walls to fold the plurality of walls along the fold-lines.

Optionally the paint container may further include a valve, wherein the dispensing opening is formed in the valve. The provision of a valve in the paint container provides improved control over the dispensing of the paint from the bore of the paint container. Such a valve may be configured as a one-way valve.

According to a second aspect of the invention, there is provided a method of dispensing paint from a paint container, the paint container comprising: a plurality of walls arranged circumferentially to form a hollow enclosure with a bore within which a volume of paint may be contained, each of the plurality of walls being divided from each neighboring wall by a respective fold-line; and a dispensing opening arranged to permit dispensing of any paint contained within the volume,
wherein the method comprises the step of applying a force to the plurality of walls to fold the plurality of walls along the fold-lines in order to apply pressure to any volume of paint contained within the bore to dispense paint through the dispensing opening.

It will be appreciated that the advantages and features of the first aspect of the invention apply mutatis mutandis to the second aspect of the invention.

### BRIEF DESCRIPTION OF THE DRAWINGS

Preferred embodiments of the invention will now be described, by way of non-limiting examples, with reference to the accompanying drawings in which:

FIG. 1 shows a front perspective view of a paint container according to a first embodiment of the invention, having a square cross-section and in an unfolded state.

FIG. 2 shows a top view of the paint container of FIG. 1.

FIG. 3 shows a rear view of the paint container of FIG. 1.

FIG. 4 shows a left side view of the paint container of FIG. 1, which is identical to a right side view of the paint container.

FIG. 5 shows a front view of the paint container of FIG. 1.

FIG. 6 shows a bottom view of the paint container of FIG. 1.

FIG. 7 shows a rear perspective view of the paint container of FIG. 1.

FIG. 8 shows a front perspective view of a dispensing opening for the paint container of FIG. 1.

FIG. 9 shows a front perspective view of the paint container of FIG. 1 in a folded state, when an external force is applied to a wall forming part of the paint container.

FIG. 10 shows a left side view of the paint container of FIG. 9.

FIG. 11 shows a front view of the paint container of FIG. 9.

FIG. 12 shows a top view of the paint container of FIG. 9, which is identical to a bottom side view of the paint container.

FIG. 13 shows a rear view of the paint container of FIG. 9.

FIG. 14 shows a right side view of the paint container of FIG. 9.

FIG. 15 shows a rear perspective view of the paint container of FIG. 9.

FIG. 16 shows a front perspective view of a paint container according to a second embodiment of the invention, having a hexagonal cross-section in an unfolded state.

FIG. 17 shows a top view of the paint container of FIG. 16.

FIG. 18 shows a rear view of the paint container of FIG. 16.

FIG. 19 shows a left side view of the paint container of FIG. 16, which is identical to a ride side view of the paint container.

FIG. 20 shows a front view of the paint container of FIG. 16.

FIG. 21 shows a bottom view of the paint container of FIG. 16.

FIG. 22 shows a front perspective view of the paint container of FIG. 16 in a folded state. when an external force is applied to a wall forming part of the paint container.

FIG. 23 shows a left side view of the paint container of FIG. 22.

FIG. 24 shows a front view of the paint container of FIG. 22.

FIG. 25 shows a top view of the paint container of FIG. 22, which is identical to a bottom view of the paint container.

FIG. 26 shows a rear view of the paint container of FIG. 22.

FIG. 27 shows a right side view of the paint container of FIG. 22.

FIG. 28 shows a rear perspective view of the paint container of FIG. 22.

FIG. 29 shows a front perspective view of a paint container according to a third embodiment of the invention, having an octagonal cross-section in an unfolded state.

FIG. 30 shows a top view of the paint container of FIG. 29.

FIG. 31 shows a rear view of the paint container of FIG. 29.

FIG. 32 shows a left side view of the paint container of FIG. 29, which is identical to a right side view of the paint container.

FIG. 33 shows a front view of the paint container of FIG. 29.

FIG. 34 shows a bottom view of the paint container of FIG. 29.

FIG. 35 shows a rear perspective view of the paint container of FIG. 29.

FIG. 36 shows a rear perspective view of the paint container of FIG. 29 in a folded state, when an external force is applied to a wall forming part of the paint container.

FIG. 37 shows a left side view of the paint container of FIG. 36.

FIG. 38 shows a front view of the paint container of FIG. 36.

FIG. 39 shows a top view of the paint container of FIG. 36, which is identical to a bottom view of the paint container.

FIG. 40 shows a rear view of the paint container of FIG. 36.

FIG. 41 shows a front perspective view of the paint container of FIG. 36.

FIG. 42 shows a front perspective view of a paint container according to a fourth embodiment of the invention, having another octagonal cross-section in an unfolded state.

FIG. 43 shows a top view of the paint container of FIG. 421.

FIG. 44 shows a front view of the paint container of FIG. 42.

FIG. 45 shows a right side view of the paint container of FIG. 42, which is identical to a left side view of the paint container.

FIG. 46 shows a rear view of the paint container of FIG. 42.

FIG. 47 shows a rear perspective view of the paint container of FIG. 42.

FIG. 48 shows a front perspective view of the paint container of FIG. 42 in a folded state, when an external force is applied to a wall forming part of the paint container.

FIG. 49 shows a left side view of the paint container of FIG. 48.

FIG. 50 shows a front view of the paint container of FIG. 48.

FIG. 51 shows a top view of the paint container of FIG. 48, which is identical to a bottom view of the paint container.

FIG. 52 shows a rear view of the paint container of FIG. 48.

FIG. 53 shows a right side view of the paint container of FIG. 48.

FIG. 54 shows a rear perspective view of the paint container of FIG. 48.

### DETAILED DESCRIPTION

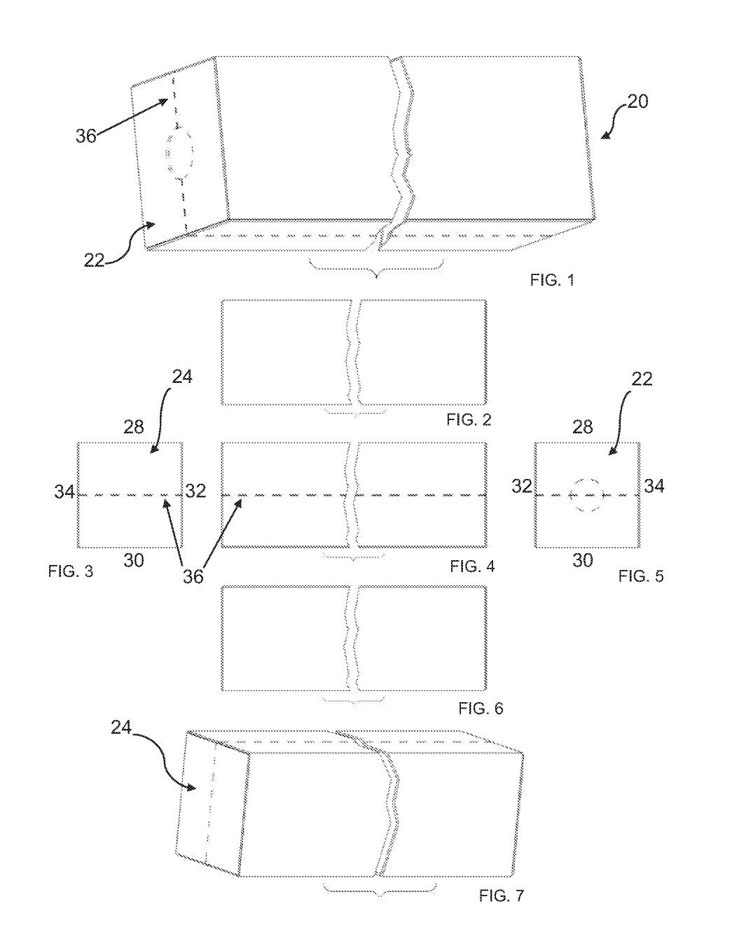

A paint container 20 according to a first embodiment of the invention is shown in FIGS. 1 to 8 and is designated generally by the reference numeral 20.

The paint container 20 comprises a plurality of planar walls, a first end face 22, a second end face 24, and a dispensing opening 26.

The plurality of walls are arranged circumferentially in a square circumference to form a hollow enclosure with a bore within which a volume of paint may be contained.

A first side 28 of the square circumference is formed by a first of the plurality of walls, a second side 30 of the square circumference is formed by a second of the plurality of walls, and the first and second sides 28,30 define opposite sides of the square circumference. A third side 32 of the square circumference is formed by two of the remaining plurality of walls, a fourth side 34 of the square circumference is formed by another two of the remaining plurality of walls, and the third and fourth sides 32, 34 form opposite sides of the square circumference such that each of the third and fourth sides 32, 34 extends between the first and second sides 28, 30.

The square shape of the circumference of the hollow enclosure means that the width of the wall along the first side 28 of the square circumference is equal to the width of the wall along the second side 30 of the square circumference, the sum of the widths of the walls along the third side 32 of the square circumference is equal to the sum of the widths of the walls along the fourth side 34 of the square circumference, and the width of the wall along the first side 28 of the square circumference is equal to the sum of the widths of the walls along the third side 32 of the square circumference.

In total the paint container 20 of FIGS. 1 to 7 has eight walls, each of which is divided from each neighboring wall by a respective fold-line 36.

Each end face 22, 24 is arranged to planarly extend between the walls of the first and second sides 28, 30 of the square circumference, so as to cover the cross-section of the bore at a respective one of the axial ends of the bore. Each end face 22, 24 includes two end face portions divided by a fold-line 36, whereby the fold-line 36 of each end face 22, 24 is aligned with the fold-line 36 that divides the two walls of the third side 32 of the square circumference and with the fold-line 36 that divides the two walls of the fourth side 34 of the square circumference.

The plurality of walls and end faces 22, 24 are preferably made from cardboard, but may be made from other materials.

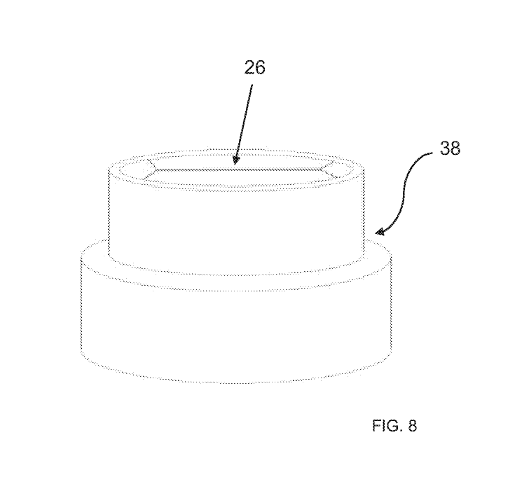

The dispensing opening 26 is formed in a valve 38 on the first end face 22, and is in the form of a circular aperture. An example of the valve 38 is shown in FIG. 8. It is envisaged that, in other embodiments of the invention, the dispensing opening may have a different shape, instead of a circular shape, and that other types of valves may be used in place of the valve 38 shown in FIG. 8.

The purpose of including the fold-lines 36 in the paint container 20 in the foregoing manner is to permit application of a force to the plurality of walls to fold the plurality of walls and each end-face along their respective fold-lines 36.

A method of dispensing paint from the paint container 20 of FIGS. 1 to 8 is described as follows, with reference to FIGS. 1 to 15.

In use, a volume of paint is contained within the bore of the paint container 20. More specifically, the volume of paint is stored in a metalized bag (not shown), which is preferably heat sealed, and the metalized bag is contained within the bore of the paint container 20. The valve 38 is attached to the metalized bag to permit access to the volume of paint, and the valve 38 is arranged to protrude through the first end face 22. The volume of paint may be in the range of 0.25 liters to 10 liters.

FIGS. 1 to 7 show the shape of the paint container 20 when there is no force applied to the plurality of walls to fold the plurality of walls and each end-face along their respective fold-lines 36. The square shape of the circumference of the hollow enclosure in combination with the use of planar walls permits easy stacking of the paint container 20 with other similarly shaped paint containers.

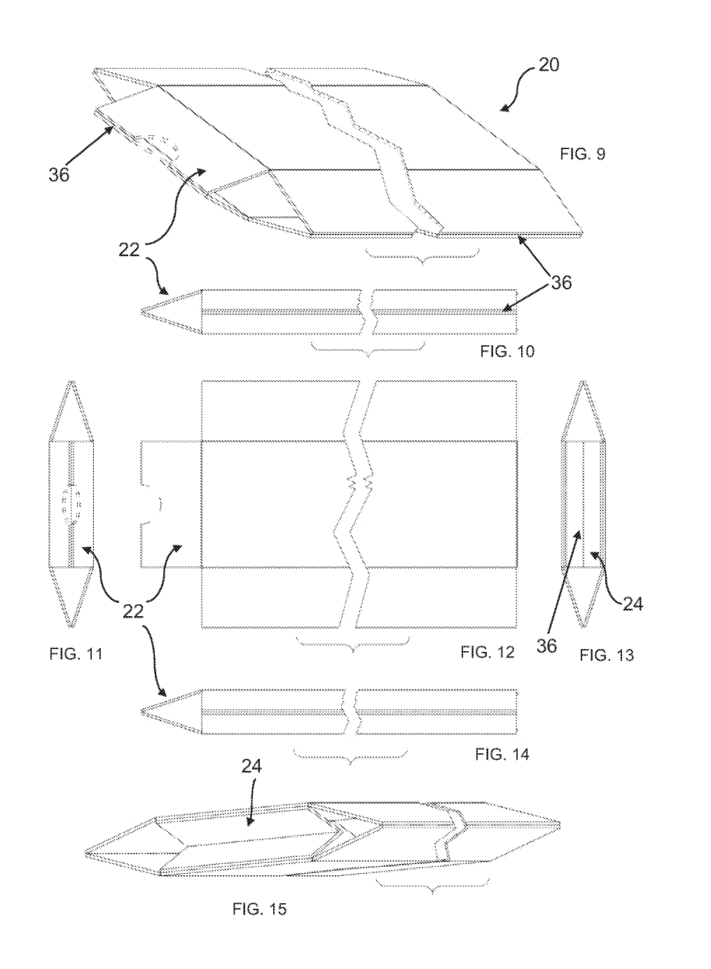

FIGS. 9 to 15 show the shape of the paint container 20 when there is an external force applied to the plurality of walls to fold the plurality of walls and each end-face along their respective fold-lines 36.

More particularly, when the external force is applied to either or both of the walls of the first and second sides 28, 30 of the square circumference, the walls of the third side 32 of the square circumference are folded along the corresponding fold-line 36 dividing the two walls to thereby reduce the inner angle between the two walls, and the walls of the fourth side 34 of the square circumference are folded along the corresponding fold-line 36 dividing the two walls to thereby reduce the inner angle between the two walls. Thus, the shape of the circumference of the hollow enclosure is changed from a square to a hexagon, as shown in FIGS. 9 to 15. This results in the application of pressure to the volume of paint contained within the bore, which in turn results in the dispensing of paint through the dispensing opening 26 on the first end face 22.

Meanwhile, upon application of the aforementioned external force, the first end face 22 (on which the dispensing opening 26 is formed) folds along its fold-line 36 and outwards away from the bore, while the second end face 24 folds along its fold-line 36 and inwards towards the bore. The latter beneficially applies additional pressure to the volume of paint contained within the bore to help dispense the paint through the dispensing opening 26.

After a chosen amount of paint is dispensed, the paint container 20 can be restored to its original pre-dispensing shape simply by re-aligning the folded walls and the end face portions to return to the shape of the paint container 20 shown in FIGS. 1 to 7.

The arrangement of the plurality of walls of FIGS. 1 to 7 therefore permits the paint container 20 to switch between: a first shape that permits easy stacking of the paint container 20; and a second shape that improves the dispensing of the paint from the paint container 20.

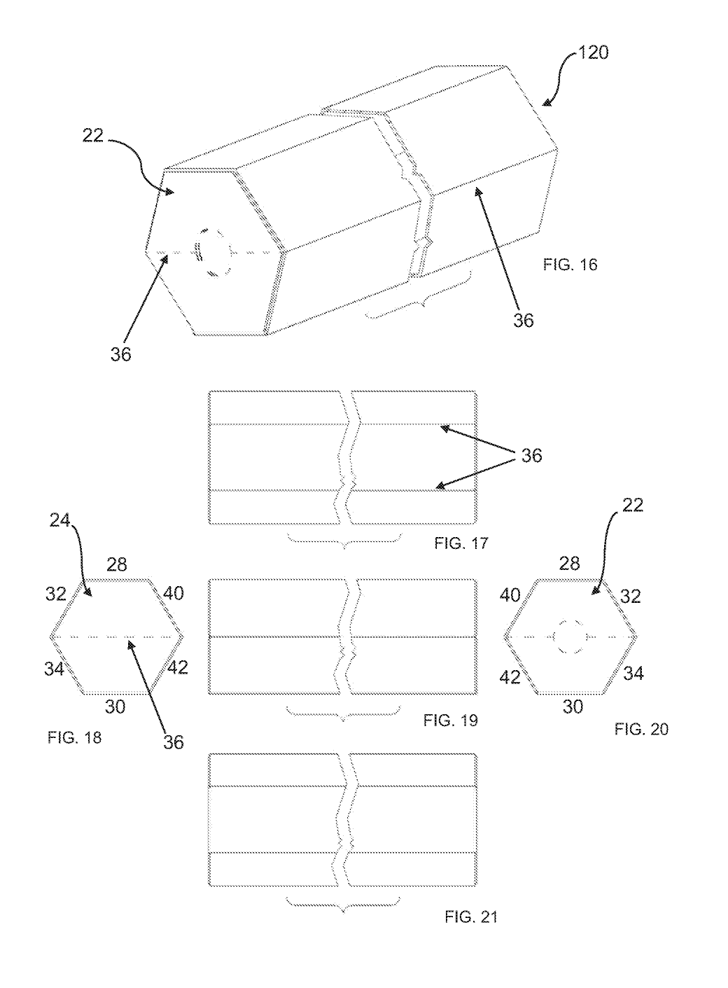

A paint container 120 according to a second embodiment of the invention is shown in FIGS. 16 to 21 and is designated generally by the reference numeral 120. The paint container 120 of FIGS. 16 to 21 is similar in structure and use to the paint container 20 of FIGS. 1 to 7 and like features share the same reference numerals.

The paint container 120 of FIGS. 16 to 21 differs from the paint container 20 of FIGS. 1 to 7 in that the plurality of walls of the paint container 120 of FIGS. 16 to 21 are arranged circumferentially in a hexagonal circumference to form a hollow enclosure with a bore within which a volume of paint may be contained.

A first side 28 of the hexagonal circumference is formed by a first of the plurality of walls, a second side 30 of the hexagonal circumference is formed by a second of the plurality of walls, and the first and second sides 28,30 define opposite sides of the hexagonal circumference. A third side 32 of the hexagonal circumference is formed by a third of the plurality of walls, a fourth side 34 of the hexagonal circumference is formed by a fourth of the plurality of walls, and the third and fourth sides 32,34 define adjacent sides that together extend between the first and second sides 28,30 of the hexagonal circumference. A fifth side 40 of the hexagonal circumference is formed by a fifth of the plurality of walls, a sixth side 42 of the hexagonal circumference is formed by a sixth of the plurality of walls, and the fifth and sixth sides 40,42 define adjacent sides that together extend between the first and second sides 28,30 of the hexagonal circumference.

In the embodiment shown in FIGS. 16 to 21, the width of the wall along each side of the hexagonal circumference is equal to the width of the respective wall along each of the other sides of the hexagonal circumference.

In total the paint container 120 of FIGS. 16 to 21 has six walls, each of which is divided from each neighboring wall by a respective fold-line 36.

Each end face 22,24 is arranged to planarly extend between the walls of the first and second sides 28,30 of the hexagonal circumference, so as to cover the cross-section of the bore at a respective one of the axial ends of the bore. Each end face 22,24 includes two end face portions divided by a fold-line 36, whereby the fold-line 36 of each end face 22,24 is aligned with the fold-line 36 that divides the two walls of the third and fourth sides 32,34 of the hexagonal circumference and with the fold-line 36 that divides the two walls of the fifth and sixth sides 40,42 of the hexagonal circumference.

A method of dispensing paint from the paint container 120 of FIGS. 16 to 21 is described as follows, with reference to FIGS. 16 to 28.

In use, a volume of paint is contained within the bore of the paint container 120 in the same manner as described above with reference to the first embodiment of FIGS. 1 to 8.

FIGS. 16 to 21 shows the shape of the paint container 120 when there is no force applied to the plurality of walls to fold the plurality of walls and each end-face along their respective fold-lines 36. The hexagonal shape of the circumference of the hollow enclosure in combination with the use of planar walls permits easy stacking of the paint container 20 with other similarly shaped paint containers.

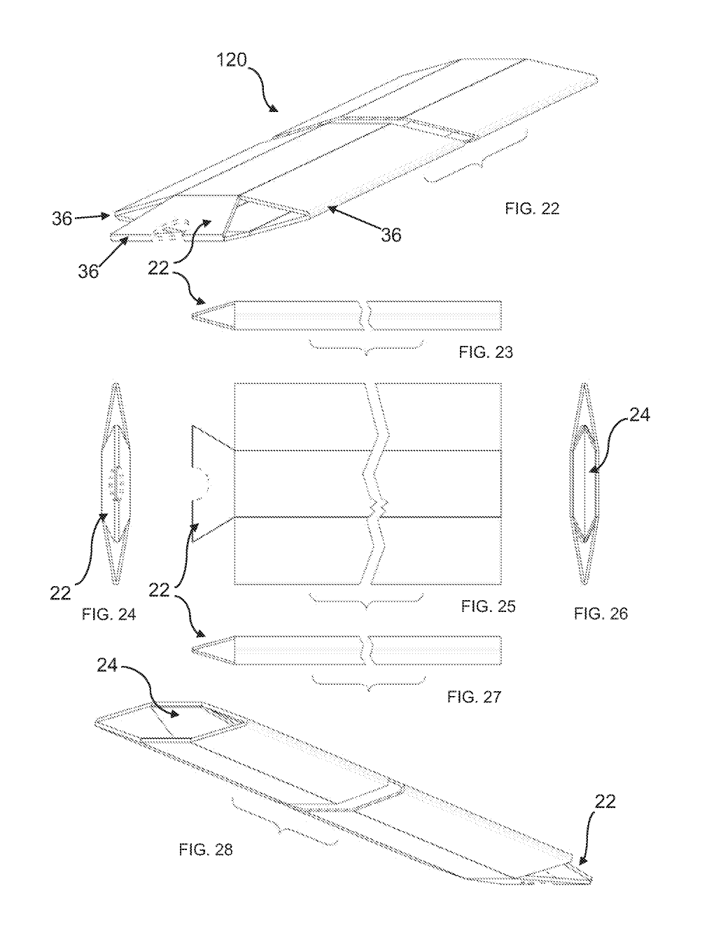

FIGS. 22 to 28 shows the shape of the paint container 120 when there is an external force applied to the first wall to fold the plurality of walls and each end-face along their respective fold-lines 36.

More particularly, when the external force is applied to either or both of the walls of the first and second sides 28, 30 of the hexagonal circumference, the third and fourth sides 32, 34 of the hexagonal circumference are folded along the corresponding fold-line 36 dividing the two walls to thereby reduce the inner angle between the two walls, and the walls of the fifth and sixth sides 40, 42 of the hexagonal circumference are folded along the corresponding fold-line 36 dividing the two walls to thereby the inner angle between the two walls. Thus, the shape of the circumference of the hollow enclosure is changed from a hexagon to a differently dimensioned hexagon, as shown in FIGS. 22 to 28. This results in the application of pressure to the volume of paint contained within the bore, which in turn results in the dispensing of paint through the dispensing opening 26 on the first end face 22.

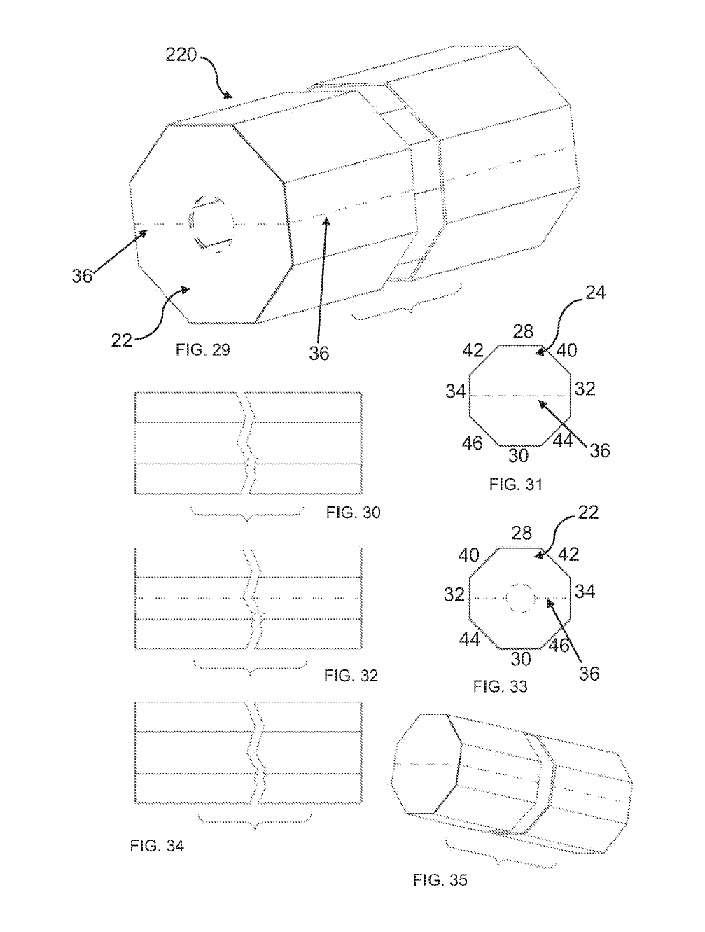

A paint container 220 according to a third embodiment of the invention is shown in FIGS. 29 to 35 and is designated generally by the reference numeral 220. The paint container 220 of FIGS. 29 to 35 is similar in structure and use to the paint container 20 of FIGS. 1 to 7 and like features share the same reference numerals.

The paint container 220 of FIGS. 29 to 35 differs from the paint container 20 of FIGS. 1 to 7 in that the plurality of walls of the paint container 220 of FIGS. 29 to 35 are arranged circumferentially in a octagonal circumference to form a hollow enclosure with a bore within which a volume of paint may be contained.

More particularly, the paint container 220 of FIGS. 29 to 35 contains fifth, sixth, seventh and eighth walls, which respectively form the fifth, sixth, seventh and eighth sides 40, 42, 44, 46 of the octagonal circumference. The fifth side 40 extends between the first and third sides 28, 32, the sixth side 42 extends between the first and fourth sides 28, 34, the seventh side 44 extends between the second and third sides 30, 32, and the eighth side 46 extends between the second and fourth sides 30, 34.

In the embodiment shown in FIGS. 29 to 35, the width of the wall along the first side 28 of the octagonal circumference is equal to the width of the wall along each of the second, fifth, sixth, seventh and eighth sides 30, 40, 42, 44, 46 of the octagonal circumference, the sum of the widths of the walls along the third side 32 of the octagonal circumference is equal to the sum of the widths of the walls along the fourth side 34 of the octagonal circumference, and the width of the wall along the first side 28 of the octagonal circumference is equal to the sum of the widths of the walls along the third side 32 of the octagonal circumference.

In total the paint container 220 of FIGS. 29 to 35 has ten walls, each of which is divided from each neighboring wall by a respective fold-line 36.

Each end face 22, 24 is arranged to planarly extend between the walls of the first and second sides 28, 30 of the octagonal circumference, so as to cover the cross-section of the bore at a respective one of the axial ends of the bore. Each end face 22, 24 includes two end face portions divided by a fold-line 36, whereby the fold-line 36 of each end face 22, 24 is aligned with the fold-line 36 that divides the two walls of the third side 32 of the octagonal circumference and with the fold-line 36 that divides the two walls of the fourth side 34 of the octagonal circumference.

A method of dispensing paint from the paint container 220 of FIGS. 29 to 35 is described as follows, with reference to FIGS. 29 to 41.

In use, a volume of paint is contained within the bore of the paint container 220 in the same manner as described above with reference to the first embodiment of FIGS. 1 to 8.

FIGS. 29 to 35 shows the shape of the paint container 220 when there is no force applied to the plurality of walls to fold the plurality of walls and each end-face along their respective fold-lines 36. The octagonal shape of the circumference of the hollow enclosure in combination with the use of planar walls permits easy stacking of the paint container 20 with other similarly shaped paint containers.

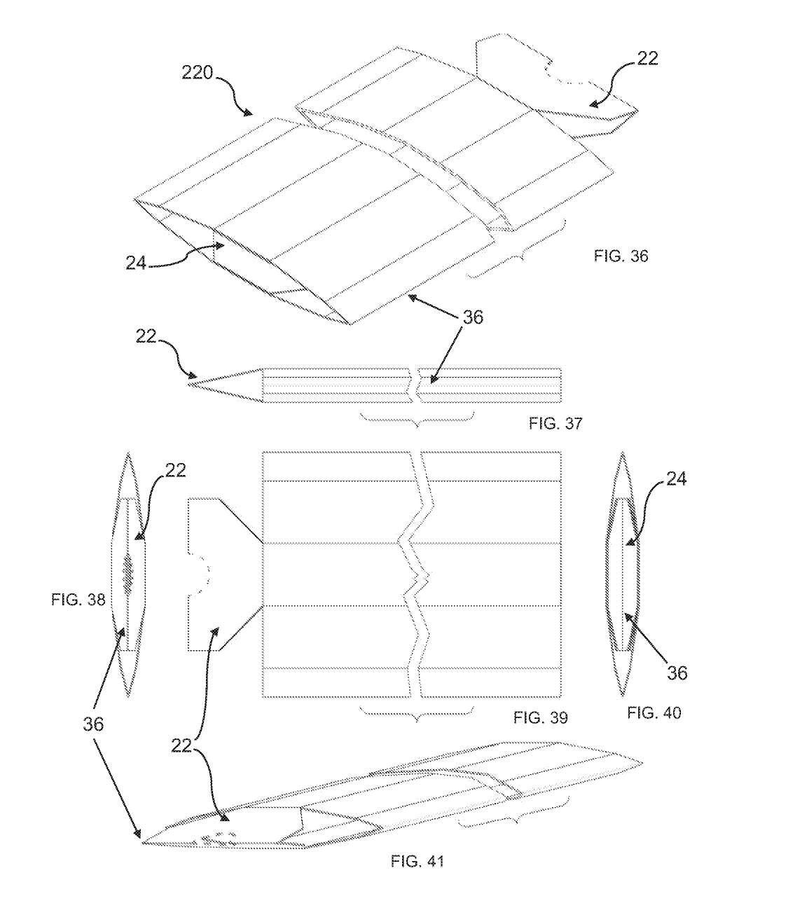

FIGS. 36 to 41 show the shape of the paint container 220 when there is an external force applied to the plurality of walls to fold the plurality of walls and each end-face along their respective fold-lines 36.

More particularly, when the external force is applied to either or both of the walls of the first and second sides 28, 30 of the octagonal circumference, the walls of the third side 32 of the octagonal circumference are folded along the corresponding fold-line 36 dividing the two walls to thereby reduce the inner angle between the two walls, and the walls of the fourth side 34 of the octagonal circumference are folded along the corresponding fold-line 36 dividing the two walls to thereby reduce the inner angle between the two walls. Thus, the shape of the circumference of the hollow enclosure is changed from an octagon to a decagon, as shown in FIGS. 36 to 41. This results in the application of pressure to the volume of paint contained within the bore, which in turn results in the dispensing of paint through the dispensing opening 26 on the first end face 22.

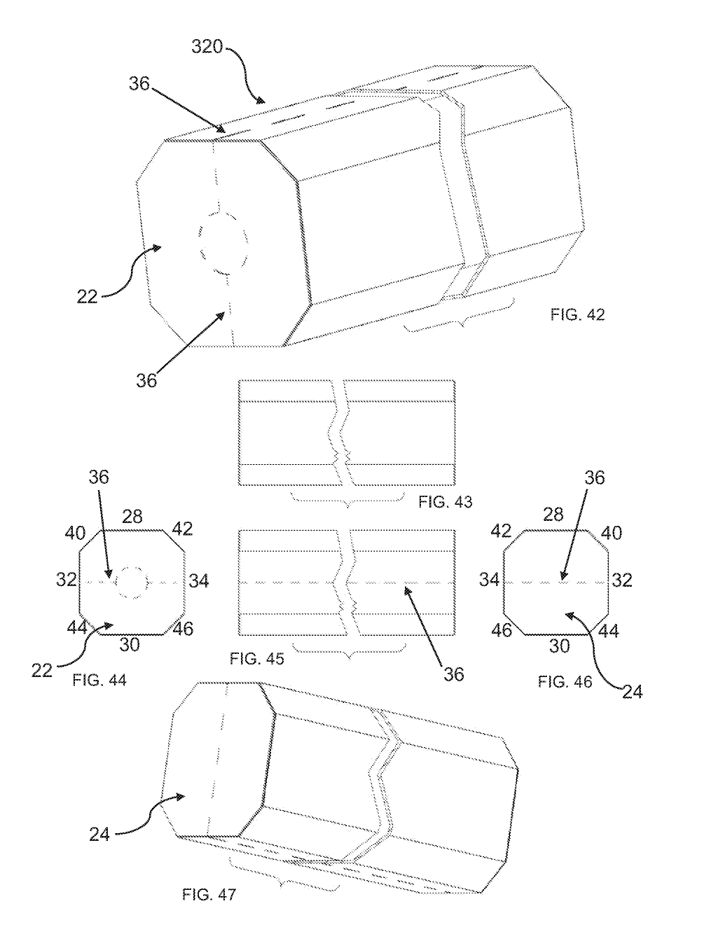

A paint container 320 according to a fourth embodiment of the invention is shown in FIGS. 42 to 47 and is designated generally by the reference numeral 320. The paint container 320 of FIGS. 42 to 47 is similar in structure and use to the paint container 220 of FIGS. 29 to 35 and like features share the same reference numerals.

The paint container 320 of FIGS. 42 to 47 differs from the paint container 220 of FIGS. 29 to 35 in that the plurality of walls of the paint container 320 of FIGS. 42 to 47 are arranged circumferentially in an differently dimensioned octagonal circumference to form the hollow enclosure.

More particularly, in the embodiment shown in FIGS. 42 to 47, the width of the wall along the first side 28 of the octagonal circumference is equal to the width of the wall along the second side 30 of the octagonal circumference, the width of the wall along the fifth side 40 of the octagonal circumference is equal to the width of the respective wall along each of the sixth, seventh and eighth sides 42, 44, 46 of the octagonal circumference, the sum of the widths of the walls along the third side 32 of the octagonal circumference is equal to the sum of the width of the walls along the fourth side 34 of the octagonal circumference, the width of the wall along the first side 28 of the octagonal circumference is equal to the sum of the widths of the walls along the third side 32 of the octagonal circumference, and the width of the wall along the first side 28 of the octagonal circumference is different from the width of the respective wall along each of the fifth, sixth, seventh and eighth sides 40, 42, 44, 46 of the octagonal circumference.

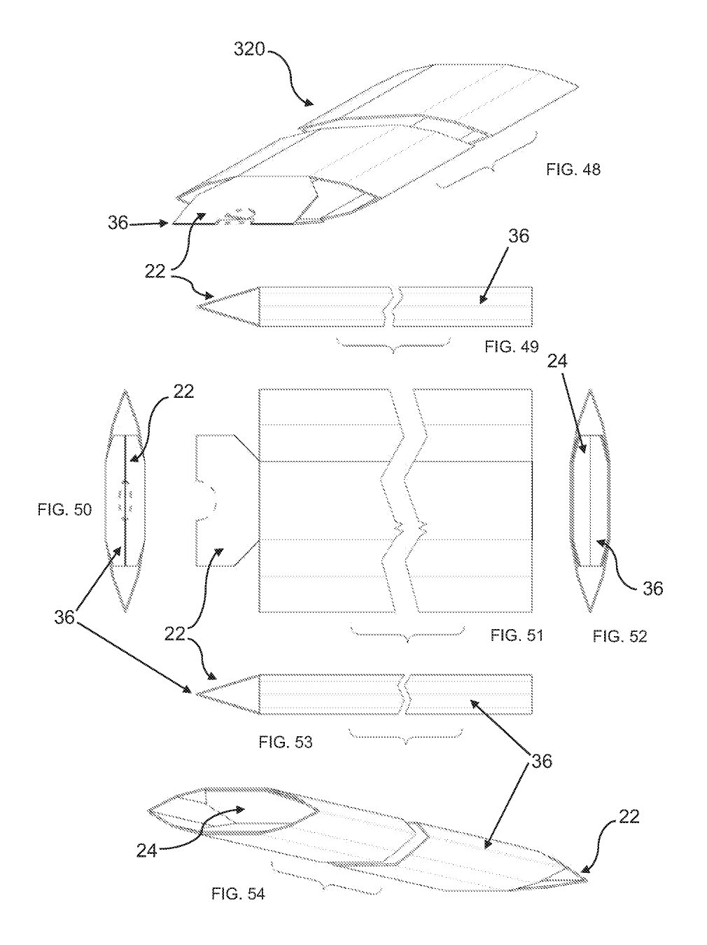

A method of dispensing paint from the paint container 20 of FIGS. 42 to 47 is described as follows, with reference to FIGS. 42 to 54.

In use, a volume of paint is contained within the bore of the paint container 20 in the same manner as described above with reference to the first embodiment of FIGS. 1 to 8.

FIGS. 42 to 47 shows the shape of the paint container 20 when there is no force applied to the plurality of walls to fold the plurality of walls and each end-face along their respective fold-lines 36. The octagonal shape of the circumference of the hollow enclosure in combination with the use of planar walls permits easy stacking of the paint container 20 with other similarly shaped paint containers.

FIGS. 42 to 54 show the shape of the paint container 20 when there is an external force applied to the plurality of walls to fold the plurality of walls and each end-face along their respective fold-lines 36.

More particularly, when the external force is applied to either or both of the walls of the first and second sides 28, 30 of the octagonal circumference, the walls of the third side 32 of the octagonal circumference are folded along the corresponding fold-line 36 dividing the two walls to thereby reduce the inner angle between the two walls, and the walls of the fourth side 34 of the octagonal circumference are folded along the corresponding fold-line 36 dividing the two walls thereby reduce the inner angle between the two walls. Thus, the shape of the circumference of the hollow enclosure is changed from an octagon to a decagon, as shown in FIGS. 42 to 47. This results in the application of pressure to the volume of paint contained within the bore, which in turn results in the dispensing of paint through the dispensing opening 26 on the first end face 22.

The arrangement of the plurality of walls and fold-lines 36 in the paint containers 20, 120, 220, 320 of FIGS. 1 to 54 therefore not only enables dispensing of the paint from within the bore of the paint container 20, 120, 220, 320, but also allows the paint container 20, 120, 220, 320 to readily return to a desired shape after the paint has been dispensed. The ability of the paint container 20, 120, 220, 320 to return to a desired shape after the paint dispensing step makes it practical to design the shape of the paint container 20, 120, 220, 320 to permit its stacking with other similarly shaped paint containers, since there is no permanent post-dispensing deformation of the paint container 20, 120, 220, 320. This not only enables space-efficient storage of the paint container 20, 120, 220, 320, but also allows the paint container 20, 120, 220, 320 to be displayed in an aesthetically pleasing fashion alongside the other similarly shaped paint containers.

1. A paint container comprising: a plurality of walls arranged circumferentially to form a hollow enclosure with a bore within which a volume of paint may be contained, each of the plurality of walls being divided from each neighboring wall by a respective fold-line; and a dispensing opening arranged to permit dispensing of any paint contained within the bore,
wherein, upon application of a force to the plurality of walls, the plurality of walls are foldable along the fold-lines in order to apply pressure to any volume of paint contained within the bore to dispense paint through the dispensing opening.

2. A paint container according to claim 1 wherein each of the plurality of walls is a planar wall.

3. A paint container according to claim 1 wherein the plurality of walls is even in number.

4. A paint container according to claim 1 wherein the plurality of walls are arranged circumferentially in a polygonal circumference to form the hollow enclosure.

5. A paint container according to claim 4 wherein the polygonal circumference is any one of: a triangular circumference; a square circumference; a rectangular circumference; a pentagonal circumference; a hexagonal circumference; an octagonal circumference; and a decagonal circumference.

6. A paint container according to claim 1 wherein the plurality of walls are arranged circumferentially in a polygonal circumference to form the hollow enclosure when there is no force applied to the plurality of walls to fold the plurality of walls along the fold-lines.

7. A paint container according to claim 1 wherein the plurality of walls are arranged circumferentially in a circumference to form the hollow enclosure, the circumference having:
a first number of corners when there is no force applied to the plurality of walls to fold the plurality of walls along the fold-lines; and
a second number of corners when there is a force applied to the plurality of walls to fold the plurality of walls along the fold-lines,
wherein the second number of corners is higher than the first number of corners.

8. A paint container according to claim 1 wherein the plurality of walls are arranged circumferentially in a circumference to form the hollow enclosure, the circumference being:
any one of: a square circumference; and a rectangular circumference, when there is no force applied to the plurality of walls to fold the plurality of walls along the fold-lines; and
a hexagonal circumference when there is a force applied to the plurality of walls to fold the plurality of walls along the fold-lines.

9. A paint container according to claim 1 wherein the plurality of walls are arranged circumferentially in a circumference to form the hollow enclosure, the circumference being:
a octagonal circumference when there is no force applied to the plurality of walls to fold the plurality of walls along the fold-lines; and
a decagonal circumference when there is a force applied to the plurality of walls to fold the plurality of walls along the fold-lines.

10. A paint container according to claim 1 wherein the plurality of walls are arranged circumferentially in a circumference to form the hollow enclosure with a plurality of first and second walls positioned alternately around the circumference, wherein the width of each first wall along the circumference is different from the width of each second wall along the circumference.

11. A paint container according to claim 1 wherein the plurality of walls are made from at least one of: cardboard, corrugated cardboard, paper covered cardboard, clay covered cardboard, paper, plastic, plastic film, and metal.

12. A paint container according to claim 1 further including an end face extending between at least two of the plurality of walls so as to cover part or all of a cross-section of the bore.

13. A paint container according to claim 12 wherein the dispensing opening is formed on the end face.

14. A paint container according to claim 12 wherein the end face is arranged to be planar when there is no force applied to the plurality of walls to fold the plurality of walls along the fold-lines.

15. A paint container according to claim 14 wherein the end face includes at least two end face portions divided by a fold-line, and the end face is arranged to fold along its fold-line and inwards towards the bore when there is a force applied to the plurality of walls to fold the plurality of walls along the fold-lines.

16. A paint container according to claim 14 wherein the end face includes at least two end face portions divided by a fold-line, and the end face is arranged to fold along its fold-line and outwards away from the bore when there is a force applied to the plurality of walls to fold the plurality of walls along the fold-lines.

17. A paint container according to claim 1 further including a valve, wherein the dispensing opening is formed in the valve.

18. A method of dispensing paint from a paint container, the paint container having a plurality of walls arranged circumferentially to form a hollow enclosure with a bore within which a volume of paint may be contained, each of the plurality of walls being divided from each neighboring wall by a respective fold-line; and a dispensing opening arranged to permit dispensing of any paint contained within the volume,
wherein the method comprises the step of applying a force to the plurality of walls to fold the plurality of walls along the fold-lines in order to apply pressure to any volume of paint contained within the bore to dispense paint through the dispensing opening.
